(19) United States
(12) Patent Application Publication
(10) Pub. No.: US 2008/0156959 A1
(43) Pub. Date: Jul. 3, 2008

(54) Magnetic shielding for display device

(75) Inventors: Christopher J. Fawcett, Charlotte, NC (US); Dennis D. Belden, Canton, OH (US)

Correspondence Address: SAND & SEBOLT, AEGIS TOWER, SUITE 1100, 4940 MUNSON STREET, NW, CANTON, OH, 44718-3615, US

(73) Assignee: Alpha Security Products, Inc., Charlotte, NC (US)

(21) Appl. No.: 11/647,015

(22) Filed: Dec. 28, 2006

(51) Int. Cl. F16M 13/00

(52) U.S. Cl. 248/551

(57) ABSTRACT

A display device has a base and an upper platform for removably supporting a retail product thereon. A sensor or attachment device includes an attachment surface for attaching the sensor to the product and has an internal magnet which magnetically couples with another magnet located in the platform to automatically orient the sensor and attached product to a desired display position on the base. A metal plate is mounted within the sensor between the internal magnet and attachment surface to provide magnetic shielding for magnetic sensitive components of the product attached to the sensor. A lanyard extends between the sensor and the base or a remote fixture and may contain electrical conductors for controlling a plunger actuated switch in the sensor.

### BACKGROUND OF THE INVENTION

1. Technical Field

The invention relates to display devices for merchandise and various retail products, and particularly to a display stand which has a supporting platform which automatically orients the item of merchandise to a desired display orientation by magnetic coupling after handling of the product by a customer. Even more particularly, the invention relates to such a display device in which the sensor component is attached to the displayed product by a lanyard and is provided with magnetic shielding to prevent harm to a magnetic sensitive component of the attached product by the orienting magnet within the sensor component.

2. Background Information

A great variety of display structures and stands have been developed for displaying retail products. Many of these display devices provide some means of securing the product to the display device to prevent unauthorized removal and theft of the product, yet which will enable a prospective customer to easily view the product, and for many products to be able to handle and inspect the product before purchase without requiring a clerk to be in attendance. This is common for displaying various types of electronic articles such as cell phones, cameras, PDA's, digital player, etc. which have a reasonably high value, but which a retailer desires to allow the potential customer to handle and inspect without the assistance of a store employee. However, there is a need to provide security against theft of such items, as well as a need to display the items of merchandise in an orderly manner.

One common solution is to attach a sensor located on the end of a lanyard to the product which contains a switch to detect and sound an alarm should the product be tampered with or removed in an unauthorized manner from the display device. Also, when a potential customer picks up an item of merchandise to inspect and then places the item back into the display area from which it was obtained but in a haphazard manner, the attached lanyards and products create quite a disorderly appearance, especially when multiple items of such merchandise are displayed near one another.

One solution to this problem provides a means for automatically orienting the product to the desired display position after it has been replaced on the display device by a magnetic coupling between a first magnet located in a sensor which is attached to the product, and a second magnet which is located on the top of the display stand or support platform. The magnetic coupling automatically rotates the sensor and attached product to the desired display position. One example of such a magnetically orienting display device is shown in pending patent application Ser. No. 11/431,291 filed May 10, 2006, the contents of which are incorporated herein by reference.

However, this could present a problem for displaying certain products which contain components which can be damaged by close proximity to a magnet, such as magnets used for self-orienting the product located in the attached sensor, or for other types of security devices having an attachment device containing a magnet wherein the device is mounted on the end of an attachment lanyard. Products most susceptible to damage by a closely located magnet would be those containing a miniature hard drive such as used in PDA's, portable video digital players, etc.

Therefore, there is a need for a display device which provides security for the displayed product, provides for the automatic orientation of the displayed product by magnetic coupling, and which shields the product, and in particular magnetic sensitive components thereof, from the orienting magnet which is contained in the sensor component which is attached in close proximity to the product.

### BRIEF SUMMARY OF THE INVENTION

The present invention provides a display device for displaying a retail product on a base or pedestal which is adapted to be mounted on a support, which device automatically orients the displayed product to a desired display position after being placed back onto the display stand by a perspective customer. This self alignment is achieved by providing magnetic coupling between a first magnet located in the support base and a second magnet located in a sensor or other component which is attached to the displayed article, which is connected to a base by a connecting lanyard or tether.

A further feature of the present invention is to provide the sensor or component which is attached to the product and which contains one of the magnets with a magnetic shield, such as a steel plate located between the product and the magnet, to prevent injury to sensitive components within the product by the orienting magnet.

Another aspect of the present invention is to position the magnetic shield approximately midway between the magnet and product and a having sufficient length and width to prevent excess leakage of the magnetic flux around the shield and into contact with the magnetically sensitive component of the product.

Another feature is to form the magnetic shield as a rectangular plate of steel, such as a 1018 grade, which plate extends generally through the length and width of the sensor housing to block as much of the magnetic flux as possible without resulting in an excessively large sensor.

Another aspect of the invention is to provide a lanyard having a device attached to one end which is adapted to be attached to an article wherein the device is provided with a magnet and a magnetic shield to protect a magnetically sensitive component in the article from damage by the magnet.

These features and advantages are obtained by the display device of the present invention, the general nature of which may be stated as including a base for mounting on a support surface; a sensor for attachment to a retail product and adapter to be supported on the base, wherein the sensor has a housing with a first surface for attaching the sensor to the product and a second surface for supporting the sensor and attached product on the base; and wherein the sensor contains a first magnet and in which a metal plate is mounted within the sensor housing between the magnet and the first surface to protect sensitive components in the product from possible harm from the orienting magnet.

### BRIEF DESCRIPTION OF THE SEVERAL VIEWS OF THE DRAWINGS

A preferred embodiment of the invention, illustrated of the best mode in which Applicant contemplates applying the principles, is set forth in the following description and is shown in the drawings and is particularly and distinctly pointed out and set forth in the appended claims.

FIG. 1 is a side elevational view with portions broken away and in section of the display device with the product attachment sensor being removed from the support base.

FIG. 2 is an enlarged sectional view of the product security sensor attached to a product containing the magnetic shielding.

FIG. 3 is a sectional view taken on line 3-3, FIG. 2.

FIG. 4 is a sectional view taken on line 4-4, FIG. 2.

Similar numbers refer to similar parts throughout the drawings.

### DETAILED DESCRIPTION OF THE INVENTION

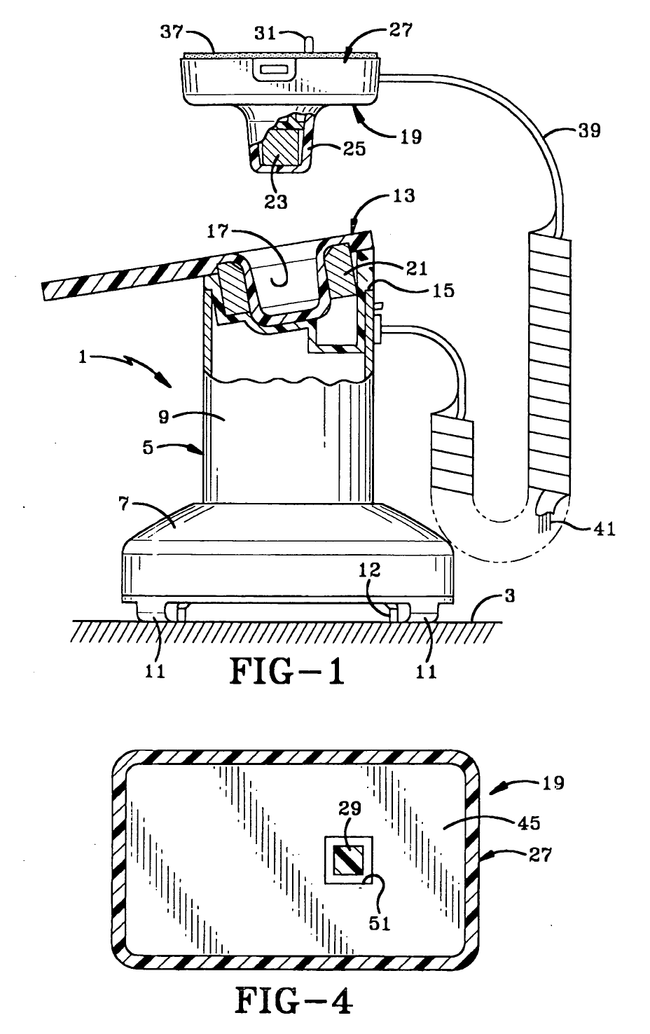

The display device of the present invention is indicated generally at 1, and is shown in FIG. 1 mounted on a support surface 3. Display device 1 includes a base indicated generally at 5, which includes a foundation 7 and a pedestal 9 extending vertically upwardly therefrom. Base 5 preferably is secured to support surface 3 by a plurality of fasteners (not shown) which can extend into threaded openings formed in a plurality of feet 11 extending from the bottom of foundation 7. This secures the display device to a support surface to prevent its unauthorized removal therefrom. If desired, a plunger 12 of an alarm switch that is mounted within base 5 can contact support surface 3 to sound an alarm if base 5 is removed therefrom.

A product support platform indicated generally at 13, is mounted on the upper end 15 of pedestal 9. Platform 13 is formed with a recess 17 in which is received a portion of a sensor 19. A ring-shaped magnet 21 is mounted within the lower portion of platform 13 and surrounds recess 17 and magnetically couples with a second magnet 23 located in an outwardly projecting post 25 which forms part of sensor housing 27 and which is seated in recess 17 when displaying a product 35 thereon. The magnetic coupling of magnets 21 and 23 provides for the self-orientation of sensor 19 with respect to platform 13 and is described in detail in pending patent application Ser. No. 11/431,291 filed May 10, 2006, the contents of which are incorporated herein by reference.

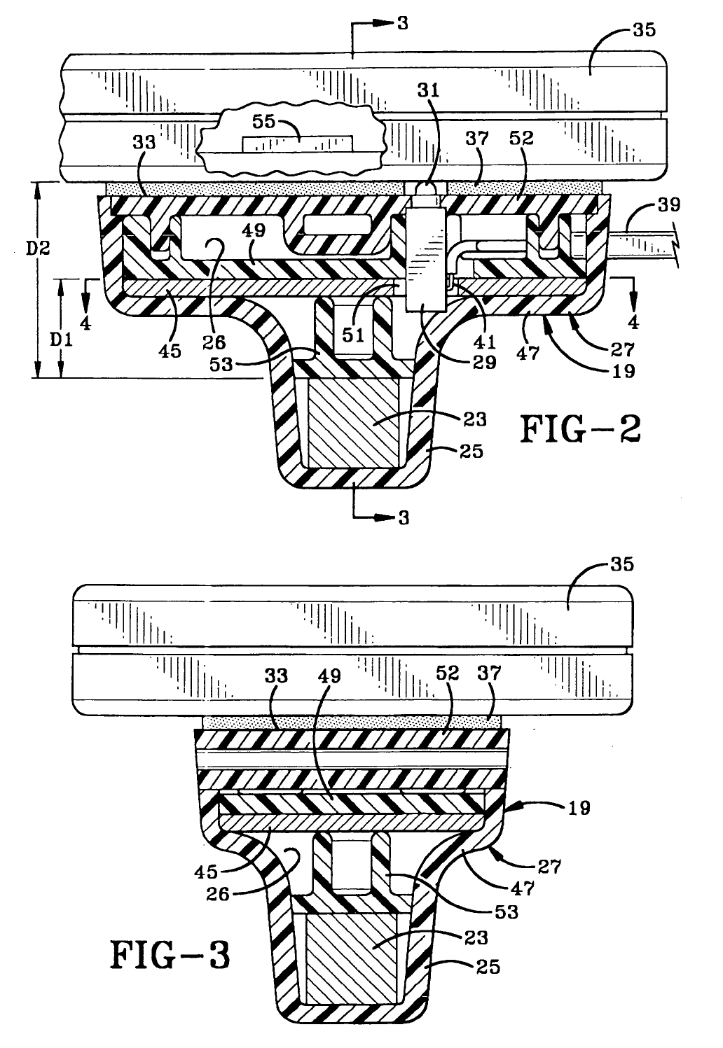

Sensor 19 may include a switch 29 mounted within the interior 26 of sensor housing 27 as shown in FIG. 2, and includes a plunger 31 which extends outwardly beyond the flat planar attachment surface 33 of housing 27 for contact with merchandise 35. Merchandise 35 preferably is attached to sensor 19 by a strip of pressure sensitive adhesive 37 or other attachment means. Switch 29 is electrically, as well as mechanically connected to base 5 by a coiled lanyard 39 which contains a plurality of electrical conductors 41 and which expands outwardly when product 35 is removed from base 5 for ease of handling and inspection by a perspective customer.

In accordance with the main feature of the invention, a magnetic shield indicated generally 45, is mounted within hollow interior 26 of housing 27 and is supported on bottom housing wall 47 in which post 25 is formed and extends outwardly therefrom. Magnetic shield 45 is clamped in position on bottom housing wall 47 by a generally flat carrier plate 49 which is secured in position by a cap 52, which forms the top closure of housing 27 and provides for the flat planar attachment surface 33 thereof. A small hole 51 is formed in magnetic shield 45 for mounting of switch 29 therein as shown in FIGS. 2 and 4. Magnet 23 is retained in position in the end of post 25 by a holder 53. Magnetic shield 45 preferably is shaped and sized to correspond with the interior of housing 27 and in the preferred embodiment has a generally rectangular shape as shown in FIG. 4 and is formed of a 1018 gauge steel with a thickness of approximately 1.3 mm. However, the size and gauge of the magnetic shield plate will vary depending upon the size of sensor 29, the strength of magnet 23, and the particular location and type of the magnetic sensitive component 55 within product 35.

An example of the improved sensor 19 as shown in FIG. 2, distance D1, which is between the magnet 23 and top surface of shield 45, is in the range generally between 7.5 and 8.0 mm, with a preferred distance of 7.8 mm, with the distance D2 between the top of magnet 23 and the bottom surface of product 35 being in range of between 15 and 16 mm, with a preferred distance of 15.4 mm. These are just examples of certain dimensions that are employed for a particular size sensor. Again, these distances can vary depending upon the size of the sensor, but is illustrative of one size of sensor that has the improved magnetic shielding incorporated therein. Likewise, the particular material of magnetic shield plate 45 can also vary in thickness and size, but preferably is as large as possible within the confines of the sensor housing in order to block as much of the magnetic flux as possible from reaching component 55 and reduce the amount of leakage extending around the edges of the magnetic shield plate by extending across the full interior of housing 27. Magnetic shield plate 45 still enables the sensor to have a security switch 29 and could also enable the incorporation of an indicating LED (not shown) incorporated therein as found in many similar types of sensors which do not incorporate the magnetic shielding of the present invention. Furthermore, the insertion of the shielding plate within the housing adds little to the cost of the sensor, and in combination with the formation of outwardly projecting post 25 in which the sensor magnet 23 is incorporated, assists in spacing the magnet a further distance from sensitive component 55.

It is readily understood that lanyard 39 can be free of electrical conductors and only mechanically connect sensor 19 or other type of attachment device containing a magnet and magnetic shield to a fixture such as base 5 or even a remotely related structure, without affecting the concept of the invention. Such a mechanical connection would eliminate the need for plunger 31 and switch 29.

Accordingly, the improved display device of the present invention provides for magnetic shielding of magnet sensitive components of certain types of equipment such as miniature hard drives, from possible damage by magnets mounted in the sensor or other type of device to which the product is attached, yet provides security to the displayed product from theft.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A display device for a retail product including:
a base for mounting on a support surface;
a sensor for attachment to a retail product and adapter to be supported on the base, said sensor having a housing with a first surface for attaching the sensor to the product and a second surface for supporting the sensor and attached product on the base, said sensor containing a first magnet; and
a magnetic shield mounted within the sensor housing between the magnet and the first surface.

2. The display device defined in claim 1 wherein a pressure sensitive adhesive is mounted on the first surface of the sensor housing for attaching the sensor to the product.

3. The display device defined in claim 1 wherein the second surface of the housing is an outwardly projecting post; and in which the magnet is mounted within a chamber formed within the post of the sensor housing.

4. The display device defined in claim 1 wherein the base includes an upper platform for removably seating the sensor thereon; and in which a second magnet is mounted within the upper platform for magnetic coupling with the first magnet for automatically orienting the sensor and attached product on the platform.

5. The display device defined in claim 4 wherein the upper platform is formed with a recess; in which the second surface of the sensor housing forms an outwardly projecting post which is removably seated in the platform recess; in which the first magnet is located within the sensor post; and in which the second magnet is a ring magnet surrounding the platform recess.

6. The display device defined in claim 1 wherein the magnetic shield is a metal plate located generally midway between the first magnet and the first surface of the sensor housing.

7. The display device defined in claim 6 wherein the metal plate is formed of a 1018 grade steel.

8. The display device defined in claim 6 wherein the metal plate is spaced from the first magnet a distance in a range of between 7.0 mm and 8.0 mm.

9. The display device defined in claim 8 wherein the magnet is spaced from the first surface of the sensor housing a distance in a range of between 15 mm and 16 mm.

10. The display device defined in claim 1 including a lanyard which mechanically and electrically connects the sensor to the base.

11. The display device defined in claim 10 wherein a switch is located within the sensor and including an actuation member which extends beyond the first surface of the house before attachment to the product.

12. In combination, an article of merchandise and a display device for displaying the merchandise in a retail environment, said merchandise containing a magnetic sensitive component, and said display device including:
a base;
a sensor attached to the article of merchandise, said sensor having a housing with a first surface for attaching the sensor to the article and a second surface for supporting the sensor and attached article on the base, said sensor containing a first magnet; and
a magnetic shield mounted within the sensor housing between the magnet and the first surface.

13. The combination defined in claim 12 wherein a pressure sensitive adhesive is mounted on the first surface of the sensor housing and attaches the sensor to the article of merchandise.

14. The combination defined in claim 12 wherein the second surface of the housing is an outwardly projecting post; and in which the first magnet is mounted within a chamber formed within the post of the sensor housing.

15. The combination defined in claim 12 wherein the base includes an upper platform for removably seating the sensor thereon; and in which a second magnet is mounted within the upper platform for magnetic coupling with the first magnet for automatically orienting the sensor and attached article.

16. The combination defined in claim 15 wherein the upper platform is formed with a recess; in which the second surface of the sensor housing forms an outwardly projecting post which is removably seated in the platform recess; in which the first magnet is located within the sensor post; and in which the second magnet is a ring magnet surrounding the platform recess.

17. The combination defined in claim 12 wherein the magnetic shield is a metal plate located generally midway between the first magnet and the first surface of the sensor housing.

18. The combination defined in claim 17 wherein the metal plate is formed of a 1018 grade steel having a thickness of approximately 1.3 mm.

19. A device for attachment to an article comprising:
a housing having a first surface for attaching the device to the article;
a magnet located within the housing;
a magnetic shield mounted within the housing between the magnet and first surface; and
a lanyard having first and second ends, said first end connected to the housing and said second end being adapted to be connected to a fixture.

20. The device defined in claim 19 wherein a sensor switch is located within the housing; and in which the lanyard contains an electrical conductor electrically connecting the sensor switch to the fixture.
